(19) United States
(12) Patent Application Publication
(10) Pub. No.: US 2002/0071405 A1
(43) Pub. Date: Jun. 13, 2002

(54) Priority channel scanning method and apparatus

(76) Inventors: Paul H. Kelley, Boca Raton, FL (US); Barbara D. Laflin, Boynton Beach, FL (US); Michael J. DeLuca, Boca Raton, FL (US); Daniel A. Morera, Boynton Beach, FL (US)

Correspondence Address: CLARITI TELECOMMUNICATIONS INTERNATIONAL, LTD., INTELLECTUAL PROPERTY DEPARTMENT, ATTN: MICHAEL J. DELUCA, 1920 CORPORATE DRIVE, BOYNTON BEACH, FL, 33426, US

(21) Appl. No.: 09/733,481

(22) Filed: Dec. 8, 2000

(51) Int. Cl. H04Q 7/00

(52) U.S. Cl. 370/332

(57) ABSTRACT

A portable receiver receives information on a network of FM SCA transmitters. Each transmitter may have a different cell size. A handoff is performed when the portable receiver travels from the coverage area of one network transmitter to another network transmitter. Fluctuations in signal quality could result in several handoffs as the portable receiver travels. Excessive handoff operations potentially reduce the battery life of the portable receiver. The portable receiver performs channel scanning and locking on a priority basis that reduces the likelihood of additional handoffs. Priority basis is assigned to a transmitter based upon indicia including its coverage area causing the portable to prefer locking on to transmitters on the basis of both signal quality and channel priority.

### FIELD OF THE INVENTION

This invention relates to channel selection for scanning receivers.

### BACKGROUND OF THE INVENTION

Signaling systems are implemented that use the FM SCA band. Such signaling systems modulate messaging information on a subcarrier in the frequency spectrum beyond the main channel frequency spectrum available to a FM radio station. One advantage of such signaling systems is the ability to establish a very large coverage area at a relatively low cost by modulating messaging signals using existing FM radio station power amplifiers, antenna towers and licensed spectrum. Often times a major metropolitan area can be covered with a network of as few as three radio stations having antenna towers located in various parts of the area. Clariti™ Telecommunications International, Ltd. has developed the ClariCAST™ messaging protocol for transmitting digitized voice and other digital messages using the FM SCA spectrum. Messages are received by a portable scanning receiver for receiving and processing digitized information. If the digitized information represents a voice message, the voice message is annunciated via an integral speaker. Clariti has designed the VOCATM player scanning receiver capable of receiving and annunciating a digitized voice message transmitted on the FM SCA spectrum.

Each FM radio station used in an FM SCA network covering a metropolitan area has a different frequency and may have a different cell size, or coverage area size. The cell size varies due to the radio station's licensed power transmission, height and location of the transmitting antenna on a transmit tower, and the amount of modulation provided for the subcarrier communicating the message information. Thus, a metropolitan network may be covered by cells having significantly different sizes.

As a portable receiver is moved through the metropolitan area, it travels from cell to cell. When leaving one cell and entering another cell, a handoff is performed as it switches from receiving one transmitter frequency to another transmitter frequency. Fluctuations in signal quality could result in several handoffs as the portable receiver travels. Excessive handoff operations potentially reduce the battery life of the portable receiver. A handoff requires a scanning process and a channel acquisition process. Since the portable device is battery powered, conservation of the battery power is very desirable. The scanning process and the channel acquisition process can consume a significant amount of battery power, thus it is desirable to reduce the amount of handoffs as a receiver is moved through the metropolitan area.

Thus, what is needed is a method and apparatus for reducing the number of handoffs of a portable receiver.

### BRIEF DESCRIPTION OF THE DRAWINGS

FIG. 1 shows an example metropolitan area having transmitters forming cells of various sizes.

FIG. 2 shows a block diagram of a portable receiver operating in accordance with the present invention.

FIG. 3 shows an example of a scan table in accordance with a first embodiment of the present invention.

FIG. 4 shows a flowchart of a process for locking on to a channel in accordance with the first embodiment of the present invention.

FIG. 5 shows a more detailed flowchart of a process for determining signal quality.

FIG. 6 shows an example of a scan table in accordance with a an alternate embodiment of the present invention.

FIG. 7 shows a flowchart of a process for locking on to a channel in accordance with the alternate embodiment of the present invention.

### DETAILED DESCRIPTION OF THE INVENTION

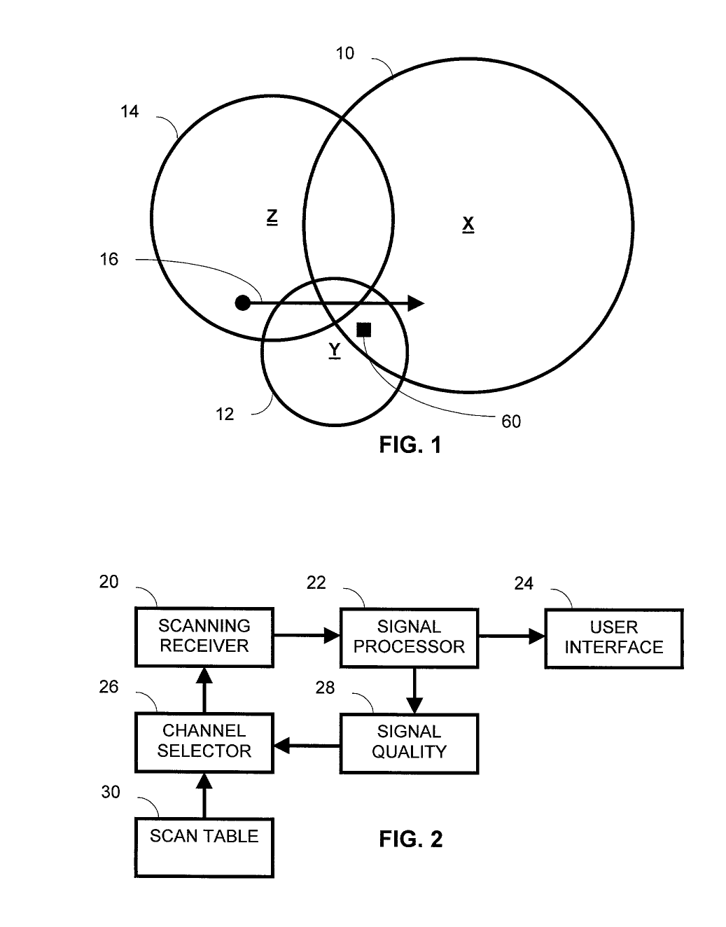

FIG. 1 shows an example metropolitan area having transmitters forming a network of cells of various sizes. Transmitter X creates the largest cell coverage area which is substantially shown by the circle 10. Transmitter X may be a 100 kW transmitter having a very high antenna and 10% subcarrier modulation. Transmitter Y creates the smallest cell coverage area which is substantially shown by the circle 12. Transmitter Y may be a 8 kW transmitter having a relatively low antenna and 5% subcarrier modulation. Transmitter Z creates a mid-sized cell coverage area which is substantially shown by the circle 14. Transmitter Z may be a 50 kW transmitter having a high antenna and 8% subcarrier modulation. Overlap zones are created at the intersection of each circle. In an overlap zone signals from multiple transmitters may be received by the portable receiver. There are four overlap zones in FIG. 1. The overlap between circles 10 and 12, 10 and 14, 12 and 14, and 10, 12 and 14. Arrow 16 shows an example of a portable receiver traveling through the metropolitan area. The portable receiver starts in the coverage area of transmitter Z, travels to overlapping coverage area of transmitters Z and Y, then to overlapping coverage area of transmitters Z, Y and X, then to overlapping coverage area of transmitters Y and X and then to coverage area of transmitter X. While in and traveling through overlap zones a portable receiver has opportunity to perform handoff functions.

FIG. 2 shows a block diagram of a portable receiver operating in accordance with the present invention. The portable receiver has a scanning receiver 20 capable of receiving and demodulating message information from any one of the network transmitters. The scanning receiver preferably includes a programmable frequency synthesizer for selecting reception of any one of the network transmitters. Signal processor 22 further removes the messaging signals from the subcarrier, performs symbol and frame synchronization and then process the digital information to recover any messages for the portable receiver. The signal processor is preferably implemented in an application specific integrated circuit. The messages are then presented to the user interface function which stores the message and then presents the message to a user of the portable device. The user interface preferably includes a display, user interface buttons, a microcontroller, message memory and a vocoder for converting digitized voice messages to an audio signal for annunciation to the user through a speaker. Channel selector 26 programs the synthesizer in scanning receiver 20 to receive signals from selected network channels. Channel selector 26 uses signal quality determinations from signal quality determiner 28. Signal quality determiner processes signals from signal processor 22 and is preferably a function implemented within the application specific integrated circuit implementing signal processor 22. Scan table 30 is a table with a list identifying and prioritizing the network transmitter frequencies. Channel selector 26 and scan table 30 are preferably implement in the microprocessor and memory used to implement user interface 24.

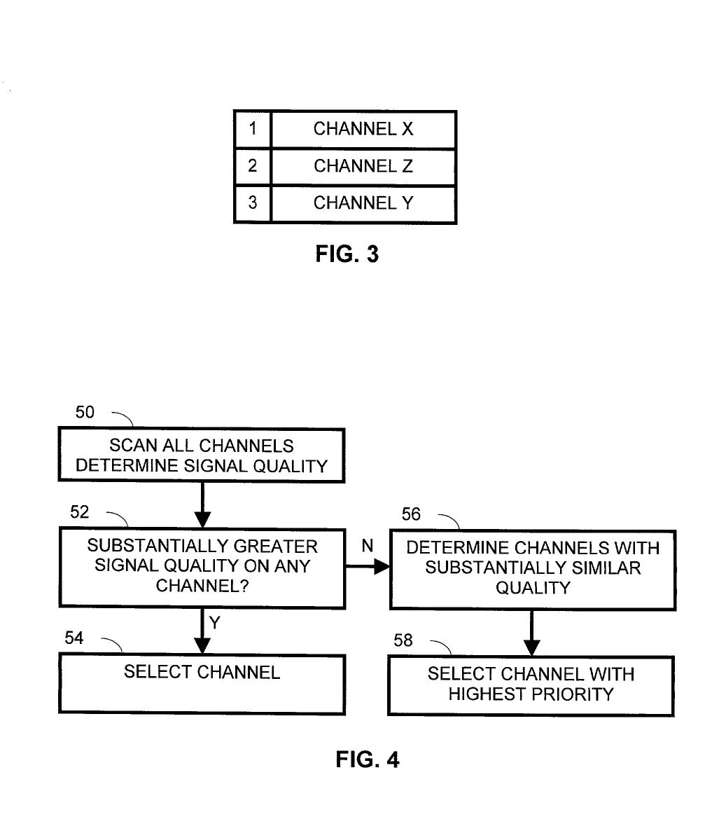

FIG. 3 shows an example of a scan table in accordance with the first embodiment of the present invention. The table has a scan list with information indicative of a frequency and subcarrier setting for receiver information from the three channel corresponding to the three transmitters of FIG. 1. Channel X is in the first position, Channel Z is in the second position and channel Y is in the third position. In the preferred embodiment the channel position is determined by the channel having the largest coverage area given the first position and sequenced based upon decreasing coverage area. The channel sequencing in this manner helps reduce the number of handoffs by causing a portable receiver to lock onto the channel with the largest coverage area when two channels have similar signal quality measurements. Locking onto the channel with the largest coverage reduces the average possibility that the portable receiver will need to perform a handoff while traveling.

FIG. 4 shows a flowchart of a process for locking on to a channel in accordance with the first embodiment of the present invention. Step 50 scans all channels in the channel list and determines the signal quality of each channel. The signal quality generates normalized values between 00 and 99 having the highest and lowest respective quality determinations. Then step 50 determines if any one channel has a substantially greater signal quality. In the preferred embodiment, if one channel is more than five better than any other channel, then step 52 is satisfied. In the preferred embodiment, a value of 5 is added to the channel with best or lowest signal quality value. If the channel still has the lowest value, then its signal quality is substantially greater than any other channel and the process proceeds to step 54 to select that channel for locking on. If after the addition performed in step 52, the channel does not have the lowest value, then all channels having a lower value are determined to have a substantially similar signal quality in step 56. Then, of the channels having a substantially similar signal quality, the channel with highest priority from the channel list is selected for locking at step 58.

As an example, a portable receiver located at point 60 of FIG. 1 is in range of transmitters X and Y but not Z. A lower signal quality measurement indicates a higher quality signal. If the signal quality measurement resulted in X=30, Y=26, Z=fail, the process of FIG. 4 would lock on to X even tough Y had a better signal quality measurement. Step 52 adds 5 to 26 for a value of 31 and Y no longer has the best value. Step 56 determines that X and Y are the only channels having substantially similar quality, so step 58 selects between channels X and Y based upon priority. Channel X is in the first position of the channel list of FIG. 3 and channel Y is in the third position. Thus, channel X has the highest priority because of its position and step 58 selects channel X for locking on to.

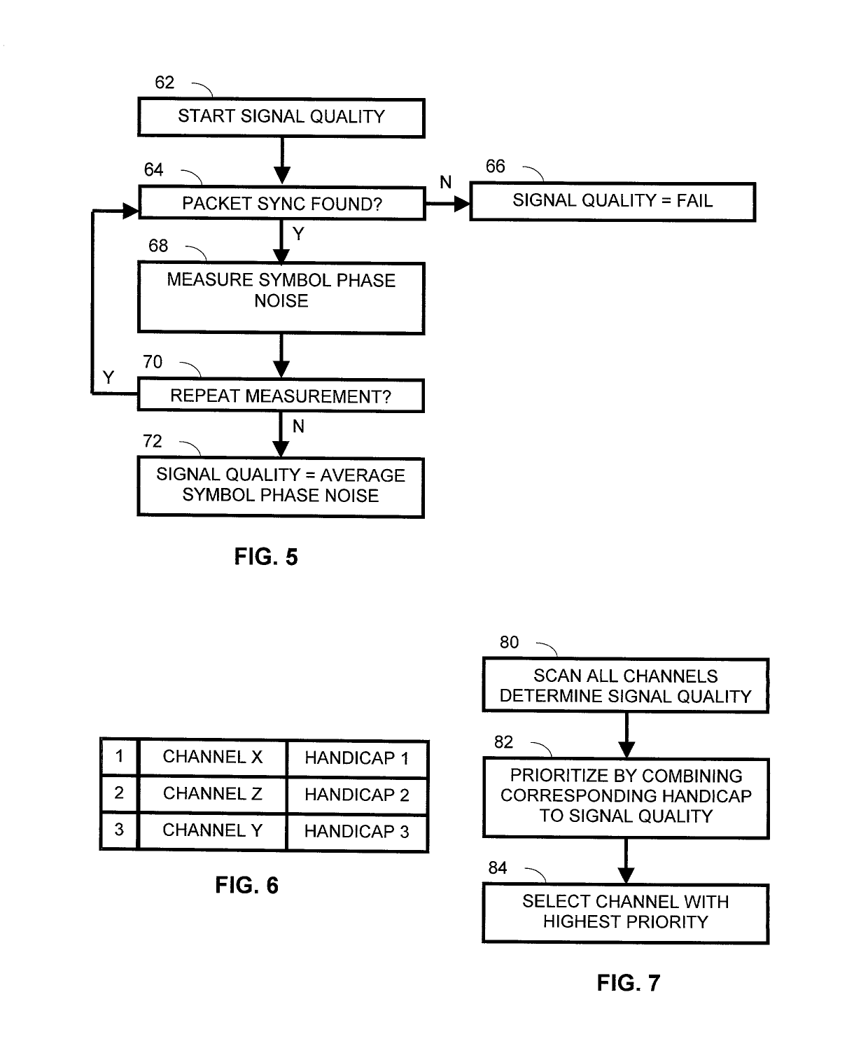

FIG. 5 shows a more detailed flowchart of a process for determining signal quality. The process starts with step 62 where a channel is selected, the receiver is activated and the received signals are processed. The received signal includes pilot symbols marking packet information boundaries. Step 64 determines if the pilot symbols are detected and thus packet synchronization found. If not found then the signal quality for the selected channel is determined to “fail”. If packet sync is found then the symbol phase noise of the received signal is measured and a normalized value between 00 and 99 computed at step 68. A signal with very little phase noise is better in quality and has a low value while a signal with a lot of phase noise is poorer in quality had has a higher value. Steps 64 and 68 may be repeated several times by step 70. If the signal quality has not failed at step 66, then step 72 determines the signal quality to be the average phase noise measurements. It should be appreciated that in the preferred embodiment signal quality is determined by packet synchronization in combination with symbol phase noise. In alternate embodiments other methods of determining signal quality are contemplated including signal quality based upon symbol phase noise alone, the quality of pilot symbols processed during packet synchronization, a real time signal strength indication (RSSI), and/or parameters generated by error detection and error correction algorithms.

FIG. 6 shows an example of a scan table in accordance with an alternate embodiment of the present invention. Channel prioritization is based upon a handicap value assigned to each channel. In this embodiment the handicap value is chosen to prioritize a channel with a larger coverage area over a channel with a smaller coverage area. For example channel X could have a handicap of 5 because it has the largest coverage area. Channel Y could have a handicap of zero because it has the smallest coverage area. Channel Z could have a handicap value of 2 because it has an intermediate coverage area. Since it is possible in some applications to have a network with many cells, some having substantially the same coverage area size, the channels are optionally sequenced to provide an additional channel prioritization indicia if the handicapping results in a substantial tie. The additional channel prioritization would preferably be in accordance with the process of FIG. 4.

FIG. 7 shows a flowchart of a process for locking on to a channel in accordance with the alternate embodiment of the present invention. In step 80 all channels are scanned and the signal quality for each channel determined. Then in step 82 the signal quality result is combined with the corresponding handicap value from the scan table of FIG. 6 to produce a handicapped signal quality. Then the channel having best handicapped signal quality is assigned the highest priority and selected for locking on to.

As an example, a portable receiver located at point 60 of FIG. 1 is in range of transmitters X and Y but not Z. If the signal quality measurement resulted in X=30, Y=26, Z=fail. The example handicap values from the table of FIG. 6 were X=5, Y=0 and Z=2. The process would lock onto X even tough Y had a better signal quality measurement. Step 82 subtracts 5 from 30 for a value of 25 for the handicapped signal quality of channel X, eliminates channel Z because of the failure and subtracts a value of 0 from 26 resulting in 26 for the handicapped signal quality of channel Y. Thus, the handicapped signal quality values of channels X and Y are 25 and 26 respectively. Step 84 then selects channel X for locking on to because it has the highest priority resulting from having the best handicapped signal quality value.

In an optional embodiment, if in the above example channel X measure a signal quality value of 31 instead of 30, then the handicapped signal quality values of channels X and Y would be equivalent values of 26. By adding the process of steps 56 and 58 of FIG. 4 after step 84 of FIG. 4, the equality could be resolved by selecting the channel based upon its position in the table of FIG. 6. Note further that this optional embodiment may be used if the handicapped signal quality values are substantially equivalent. In this example substantially equivalent could mean a difference of one or two in the handicapped signal quality values.

The channel selection processes of FIG. 4 and FIG. 7 may be evoked under several conditions within the portable receiver. The channel selection processes may be evoked when the portable receiver is first powered ON, or when it is determined that the signal quality of a channel to which the portable receiver is currently locked on is degrading, or at other arbitrary events or periodic intervals.

One advantage of the invention is the statistical likelihood of a decrease in handoff activity on the part of the portable receiver. If the portable receiver is located at position 60 of FIG. 1, then it will lock on to transmitter X rather than transmitter Y even though transmitter Y may have a better signal quality. Handoffs are statistically reduced because it is more likely that the portable receiver will remain in coverage area of transmitter X than in the coverage area of transmitter Y because transmitter X has a larger coverage area. Note in alternate embodiments, the prioritization of the channels of FIG. 3 and FIG. 6 may be made on the basis of criterion other than transmitter coverage area. For example, a smaller coverage area with a statistically more dense population of portable receivers may be given more priority than a larger coverage area with a less dense population of portable receivers. Also, buildings, mountains or other radio frequency absorbers or reflectors may cause holes in the coverage area of a first transmitter. The hole may be filled with a smaller transmitter on a different frequency having a coverage area included substantially entirely within the first transmitter. Prioritization of the second fill transmitter may be set to encourage locking on onely substantially within the hole. This may be done by placing the second transmitter channel at the bottom of the list of FIG. 3 or giving it a relatively smaller handicap or a negative handicap on the list of table 6.

Thus, what is provided is a method and apparatus for reducing the number of handoffs of a portable receiver.

We claim:

1. A method of selecting reception of one of a plurality of radio frequency channels by a portable radio frequency receiver capable of receiving each of the plurality of channels, the comprising the steps of:
measuring a signal quality for each of the plurality of channels;
choosing one of the plurality of channels if its corresponding signal quality is substantially better than all other of the plurality of channels; or determining if at least two of the plurality of channels have substantially similar signal qualities; and
selecting one of the two channels in response to the one channel having a higher determined priority relative to other of the at least two channels.

2. The method according to claim 1 wherein the plurality of radio channels include digital information modulated upon a multiplicity of symbols transmitted at a predetermined symbol rate and
said step of measuring signal quality determines a received quality for a plurality of the multiplicity of symbols.

3. The method according to claim 1 wherein the plurality of radio channels include digital information modulated upon a multiplicity of symbols transmitted at a predetermined symbol rate, the multiplicity of symbols including pilot signals and
said step of measuring signal quality further comprises the steps of:
determining a presence of the pilot signals; and
determining a received quality for a plurality of the multiplicity of symbols.

4. The method according to claim 1 wherein the receiver stores the plurality of channels in a list having the plurality of channels stored in a predetermined sequence and the determined priority of each of the plurality of channels corresponds to its predetermined sequence in the list.

5. The method according to claim 4 wherein the predetermined sequence is determined by a coverage area of each channel of the plurality of channels wherein a channel with a larger coverage area has the higher determined priority than a channel with a smaller coverage area.

6. The method according to claim 1 wherein the receiver stores the plurality of channels in a list, each channel having a corresponding handicap value and said step of selecting further comprises the steps of:
combining the handicap value with each corresponding signal quality value to produce a handicapped signal quality value for each of the at least two channels; and
prioritizing the at least two channels in response to said step of combining wherein the channel with the higher determined priority has a better handicapped signal quality value.

7. The method according to claim 1 wherein
said step of measuring measures a signal quality value corresponding to each of the plurality of channels,
said step of choosing chooses the one of the plurality of channels if it has a signal quality value more than a predetermined amount greater than corresponding signals quality values of other of the predetermined channels, and
said step of determining determines if the at least two channels are substantially similar if a difference between the corresponding signal quality values of the at least two channels is less than another predetermined amount.

8. The method according to claim 7 wherein the receiver stores the plurality of channels in a list having the plurality of channels stored in a predetermined sequence and the determined priority of each of the plurality of channels corresponds to its predetermined sequence.

9. The method according to claim 7 wherein the list further includes a corresponding handicap value and said step of selecting further comprises the steps of:
combining the corresponding handicap value to each of the corresponding signal quality values to produce a handicapped signal quality value for each of the at least two channels; and
prioritizing the at least channels in response to said step of combining wherein the channel with the higher determined priority has a greater handicapped signal quality value.

10. A scanning receiver for selecting one of a plurality of radio frequency channels comprising:
a signal quality detector for measuring a signal quality of each of the plurality channels;
a scan table having a priority signal corresponding to each of the plurality of channels; and
a channel selector for determining if the signal quality of at least two highest signal quality channels is substantially similar and then selecting from the determined channels in response to the corresponding priority signal.

11. The scanning receiver according to claim 10 wherein the channels communicate message information modulated at a predetermined symbol rate and further comprising:
a receiver for receiving and demodulating the message information from each of the plurality of frequency channels; and
a signal processor for determining the signal quality of each of the plurality of channels in response to the demodulated message information wherein the signal quality is determined in response to a phase noise measurement of the predetermined symbol rate.

12. The scanning receiver according to claim 10 wherein the plurality of channels communicate message information modulated at a predetermined symbol rate having pilot symbols for determining packet boundaries and further comprising:
a receiver for receiving and the demodulating message information from each of the plurality of channels; and
a signal processor for determining the signal quality of each of the plurality of channels in response to the demodulated message information wherein the signal quality is determined in response determination of packet boundaries and further in response to pilot symbols and further in response to a phase noise measurement of the predetermined symbol rate.

13. The scanning receiver according to claim 10 wherein
said scan table stores a value indicative of each of the plurality of channels in a predetermined sequence and the priority signal of each channel corresponds to the position in the sequence and
said channel selector selects from the determined channels in response to the corresponding position in the sequence.

14. The scanning receiver according to claim 10 wherein
said scan table stores a value indicative of each of the plurality of channels and a corresponding priority signal indicative of a handicap value, and
said channel selector combines the signal quality and handicap for each of the determined channels to produce a handicap signal quality value and selects from the determined channels in response to the handicap signal quality value.

15. The scanning receiver according to claim 14 wherein
said scan table stores the value indicative of each of the plurality of channels in a predetermined sequence and the priority signal of each channel further corresponds to the position in the predetermined sequence and
said channel selector further determines if the handicap signal quality of at least two of the highest signal quality frequency channels is substantially similar and selects from the further the determined channels in response corresponding position in the sequence.

16. A method of selecting reception from one of a plurality of radio frequency channels by a portable radio frequency receiver capable of receiving each of the plurality of radio frequency channels, the comprising the steps of:
measuring a signal quality for each of the plurality of channels;
combining a corresponding handicap signal with the signal quality to produce a handicapped signal quality for each of the plurality of channels; and
selecting from the plurality of channels a channel having a best handicapped signal quality.

17. The method according to claim 16 wherein the handicap signal for each of the channels is indicative of a relative coverage area for each of the corresponding channels.

18. The method according to claim 16 wherein the receiver stores the channels in a list having the plurality of channels stored in a predetermined sequence and the predetermined priority of each channel further corresponds to the sequence of the channel in the list and said step selecting further includes the steps of:
determining if at least two of the plurality of channels have substantially similar handicapped signal qualities; and
selecting one of the two channels in response to the one channel having a higher predetermined priority sequence relative to the other of the at least two channels.
